(19) United States
(12) Patent Application Publication
(10) Pub. No.: US 2020/0254801 A1
(43) Pub. Date: Aug. 13, 2020

(54) FORMED BODY

(71) Applicant: SEIREN CO., LTD., Fukui-shi (JP)

(72) Inventor: Nariaki TANAKA, Fukui-shi (JP)

(21) Appl. No.: 16/752,846

(22) Filed: Jan. 27, 2020

(30) Foreign Application Priority Data
Feb. 7, 2019 (JP) 2019-20843

(51) Int. Cl. B41M 5/00; B60R 13/02

(52) U.S. Cl. CPC B41M 5/0088; B60R 13/02

(57) ABSTRACT

Provided is a formed body in which a first region and a second region having gloss values different from each other are formed, and at least any one of the first region and the second region is a region to which an inkjet ink is applied.

### TECHNICAL FIELD

The present invention relates to a formed body. More particularly, the present invention relates to a formed body on which a plurality of regions having different degrees of matteness are formed through use of an inkjet ink.

### BACKGROUND OF THE INVENTION

Hitherto, there have been known various formed bodies to which matteness is given by coating (Japanese Patent Application Laid-Open No. 2009-113386).

### SUMMARY OF THE INVENTION

A decorative sheet described in Japanese Patent Application Laid-Open No. 2009-113386 neither discloses nor suggests forming a plurality of layers having different degrees of glossiness. Moreover, a technique of forming a plurality of regions having different degrees of matteness through use of an inkjet ink is not known.

The present invention has been made in view of such a related-art invention, and has an object to provide a formed body to which various degrees of matteness can be given through use of an inkjet ink and on which a plurality of regions having different degrees of matteness are formed.

A formed body according to the present invention for solving the problem described above mainly includes the following configurations.

(1) A formed body, comprising a first region and a second region having gloss values different from each other, wherein at least any one of the first region and the second region is a region to which an inkjet ink is applied.

According to such a configuration, the formed body has a plurality of regions having different degrees of matteness (gloss values). Moreover, the inkjet ink is applied to at least any one of the regions by an inkjet method. Therefore, a degree of matteness (gloss value) of the formed body may easily be adjusted, for example, by suitably changing conditions of inkjet printing. Further, the formed body has a plurality of regions (first region and second region) having gloss values different from each other. Therefore, as compared to a formed body to which monotonous matteness is given by coating, the design is more excellent.

(2) The formed body according to (1), wherein the inkjet ink includes particles having an average particle diameter of 0.4 to 2.5 μm, a refractive index of 1.40 to 1.70, and a specific gravity of 2.1 or less, and wherein the particles are included in at least any one of the first region and the second region.

According to such a configuration, the inkjet ink includes particles having the predetermined average particle diameter, refractive index, and specific gravity described above. Such inkjet ink including the particles described above can give various degrees of matteness and may improve the design of the formed body. Moreover, the ink is applied to the formed body by the inkjet method, and a plurality of regions having different degrees in content of the particles described above are formed, for example, by suitably changing conditions of inkjet printing. The such plurality of regions have different degrees of matteness (gloss values). The formed body has the plurality of regions (first region and second region) having gloss values different from each other. Therefore, as compared to a formed body to which monotonous matteness is given by coating, the design is more excellent. Moreover, the formed body has matteness owing to the inkjet ink including the particles described above. Thus, an inkjet device that is to be used at the time of inkjet printing is less liable to be limited. Therefore, an ejection amount for each printing can be set larger, and an ink can be applied in a short period of time. Accordingly, productivity is excellent.

(3) The formed body according to (1) or (2), further comprising: a curved surface; and a non-curved surface formed around the curved surface, wherein the first region is formed on the curved surface, and wherein the second region is formed on the non-curved surface.

According to such a configuration, different degrees of matteness may be given to the curved surface and the non-curved surface of the formed body. Therefore, for example, the formed body can give an observer such a visual impression that a curve which is larger (or smaller) than an actual degree of the curve is given. As a result, in the use limited in shape (for example, use as an interior component of an automobile), the formed body may exhibit more excellent external appearance while satisfying the limitation in shape.

(4) The formed body according to (1) or (2), further comprising: a first curved surface; and a second curved surface formed around the first curved surface, wherein the first region is formed on the first curved surface, and wherein the second region is formed on the second curved surface.

According to such a configuration, different degrees of matteness may be given to the first curved surface and the second curved surface of the formed body. Therefore, for example, the formed body can give an observer such a visual impression that a curve which is larger (or smaller) than an actual degree of the curve is given. As a result, in the use limited in shape (for example, use as an interior component of an automobile), the formed body may exhibit more excellent external appearance while satisfying the limitation in shape.

(5) The formed body according to any one of (1) to (4), wherein a difference in gloss value (AG) between the first region and the second region is from 0.5 to 95.

According to such a configuration, various designs may be given to the formed body based on the difference in matteness.

(6) The formed body according to any one of (1) to (5), wherein the formed body is an interior component of an automobile.

According to such a configuration, the formed body has a plurality of regions having different degrees of matteness. Therefore, for example, the formed body can give an observer such a visual impression that a curve which is larger (or smaller) than an actual degree of the curve is given. As a result, in a case in which the formed body is to be used as an interior component of an automobile, the formed body may exhibit more excellent external appearance while satisfying the limitation in shape demanded for an automobile interior component.

According to the present invention, a formed body to which various degrees of matteness can be given through use of an inkjet ink and on which a plurality of regions having different degrees of matteness are formed can be provided.

### BRIEF DESCRIPTION OF THE DRAWINGS

FIG. 1 is a schematic perspective view for illustrating a formed body according to one embodiment of the present invention.

FIG. 2 is a schematic perspective view for illustrating a related-art formed body to which an inkjet ink of one embodiment of the present invention is not applied.

FIG. 3 is a schematic perspective view for illustrating a formed body according to one embodiment of the present invention.

FIG. 4 is a perspective view for illustrating a related-art formed body to which an inkjet ink of one embodiment of the present invention is not applied.

FIG. 5 is a schematic perspective view for illustrating a formed body according to one embodiment of the present invention.

### DETAILED DESCRIPTION

### <Formed Body>

A formed body according to one embodiment of the present invention includes a first region and a second region having gloss values different from each other. At least any one of the first region and the second region is a region to which an inkjet ink is applied. When the formed body according to the present embodiment has such a configuration, a degree of matteness (gloss value) of the formed body may easily be adjusted, for example, by suitably changing conditions of inkjet printing. Moreover, the formed body includes a plurality of regions (first region and second region) having gloss values different from each other. Therefore, as compared to a formed body to which monotonous matteness is given by coating, the design is more excellent. In the following, a description is made of each component.

### (Outline of Formed Body)

In the formed body according to the present embodiment, the first region and the second region described above are formed on a base material. The base material may be formed into a desired shape before forming the first region and the second region or may be formed into a desired shape after forming the first region and the second region.

The base material is not particularly limited. Examples of the base material include: metal plates such as a steel plate and a metal plate made of aluminum or stainless steel; plastic plates or films made of acryl, polycarbonate, ABS, polypropylene, polyester, or vinyl chloride; a ceramic plate; concrete; lumber; and glass. Those base materials may be treated with a pretreatment agent before printing. Examples of the pretreatment agent include a fluorine-based coating material, a silicone-based coating material, an acrylic silicone-based coating material, an acryl-based coating material, an epoxy-based coating material, and a urethane-based coating material. Examples of a method of applying those pretreatment agents to the base material include a spray method, a roll coater method, a curtain flow coater method, a brush coating method, a spatula coating method, a dipping method, and an inkjet method. The base material may be fabric formed of fibers, and examples of the fibers include: polyester-based fibers such as cation dyeable polyester (CDP) fibers, polyethylene terephthalate (PET) fibers, polybutylene terephthalate (PBT) fibers, polytrimethylene terephthalate (PTT) fibers, aromatic polyester fibers, and polylactic acid fibers; acetate fibers; triacetate fibers; polyurethane fibers; nylon fibers; and composite fibers thereof. Those fibers may be suitably selected in accordance with use application. When the base material is formed of fabric, it is preferred that the fabric be treated with a pretreatment agent before printing. Examples of the pretreatment agent include a water-soluble polymer, non-water-soluble inactive organic compounds, a flame retardant, an ultraviolet absorber, a reduction inhibitor, an antioxidant, a pH conditioner, a hydrotropic agent, an antifoamer, a penetrant, and a micro-porous former. Examples of a method of applying those pretreatment agents to the fabric include a pad method, a spray method, a dipping method, a coating method, a lamination method, a gravure method, and an inkjet method.

A forming method for the base material is not particularly limited. Examples of the forming method include extrusion molding method, inflation molding method, calendar molding method, and cast molding method. The base material may be formed into a desired shape by those forming method.

The shape of the formed base material is not particularly limited. The formed base material is only required to have a three-dimensional shape formed in accordance with a desired use application and may suitably have one or a plurality of curved surfaces or a surface other than the curved surface (non-curved surface such as a flat surface). With regard to the formed body according to the present embodiment, the inkjet ink is applied to such a formed base material (or base material before being formed), and a plurality of regions (first region and second region) having gloss values different from each other are formed.

### (Inkjet Ink)

The inkjet ink (hereinafter also simply referred to as “ink”) is applied by an inkjet method to the formed base material (or base material before being formed). The ink is not particularly limited and is only required to be an ink which causes a difference in gloss value between a part to which the ink is applied and a part to which the ink is not applied or between parts to which the ink is applied. Examples of the ink include a solvent-based pigment ink, a water-based pigment ink, an aqueous dye ink, and an ultraviolet-curable pigment ink.

### Particles

It is preferred that the ink of the present embodiment include the particles from a point that the particles may give various degrees of matteness to an application surface. The particles included in the ink are not particularly limited. For example, the particles may be various inorganic particles or organic particles (beads).

The inorganic particles are made of an oxide containing metal elements such as silicon, aluminum, zinc, titanium, zirconium, yttrium, indium, antimony, tin, or tungsten. Among those, it is preferred that the inorganic particles be, for example, silica beads (refractive index: 1.44, specific gravity: 2.0) or alumina beads (refractive index: 1.63, specific gravity: 4.0) from a point that the inorganic particles have no significant difference as compared to a binder resin (for example, acrylic monomer described later) and has a relatively small specific gravity. Among those, it is preferred that the inorganic particles be silica beads from a point that the silica beads have a relatively small specific gravity. The inorganic particles may be used in combination. There is a case in which a composition may not be constant depending on a kind of inorganic particles. Therefore, the value of the refractive index is merely a general value of the inorganic particles, and there is a case in which a somewhat different value is given even with the same inorganic particles. This similarly applies to the organic particles.

Examples of the organic particles include polymethyl methacrylate beads (refractive index 1.49, specific gravity: 1.2 to 1.4), acrylic beads (refractive index 1.50, specific gravity: 1.2 to 1.4), acrylic-styrene copolymer beads (refractive index 1.54, specific gravity: 1.2 to 1.25), melamine beads (refractive index 1.57, specific gravity: 1.5 to 1.6), high refractive index melamine beads (refractive index 1.65, specific gravity: 1.5 to 1.6), polycarbonate beads (refractive index 1.57, specific gravity: 1.4 to 1.5), styrene beads (refractive index 1.60, specific gravity: 1.05 to 1.1), crosslinked polystyrene beads (refractive index 1.61, specific gravity: 1.05 to 1.1), polyvinyl chloride beads (refractive index 1.60, specific gravity: 1.35 to 1.5), benzoguanamine-melamine-formaldehyde beads (refractive index 1.68, specific gravity: 1.4 to 1.5), and silicone beads (refractive index 1.50, specific gravity: 1.3 to 1.4). Among those, it is preferred that the organic particles be crosslinked polymer microparticles such as acrylic beads, melamine beads, or acrylic-styrene copolymer beads from a point that those crosslinked polymer microparticles are less liable to swell in an ink and exhibit excellent stability of the obtained ink. It is more preferred that the organic particles be true-spherical crosslinked polymer microparticles from a point that those true-spherical crosslinked polymer microparticles are less liable to cause clogging in a nozzle or a flow passage at the time of inkjet printing and are likely to improve the ejection stability of the ink. In the present embodiment, the true-spherical shape is a smooth spherical shape substantially having no roughness or protrusions on a bead surface. Further, it is preferred that the organic particles be the melamine beads from a point that the melamine beads are particularly less liable to swell in an ink and exhibit particularly excellent stability of the obtained ink. The organic particles may be used in combination or may be composite microparticles obtained by covering surfaces of the organic particles with the inorganic particles.

It is preferred that the particles of the present embodiment include particles having an average particle diameter of 0.4 to 2.5 μm, a refractive index of 1.40 to 1.70, and a specific gravity of 2.1 or less from a point that such particles are likely to give various degrees of matteness and improve the design of the formed body. Moreover, such particles are less liable to cause clogging in the nozzle at the time of inkjet printing and are excellent in ejection stability. Further, when such particles are given, an obtained coating film is less liable to cause cloudiness, and desired matteness is likely to be given to the base material.

It is preferred that the particles have the average particle diameter of 0.4 μm or more, more preferably 0.8 μm or more. Moreover, it is preferred that the particles have the average particle diameter of 2.5 μm or less, more preferably 2.0 μm or less. When the average particle diameter falls within the range described above, the ink is likely to sufficiently exert a matting effect owing to the application of the particles. Moreover, the ink is less liable to cause clogging of the particles in the nozzle or the flow passage at the time of inkjet printing and is excellent in ejection stability. In the present embodiment, the average particle diameter can be measured through use of a particle size distribution measurement device that uses, for example, a laser diffraction scattering method as a measurement principle. Examples of the particle size distribution measurement device include a particle size distribution meter (for example, Microtrac UPA, manufactured by MicrotracBEL Corp.) that uses a dynamic light scattering method as a measurement principle.

It is preferred that the particles have the refractive index of 1.40 or more, more preferably 1.45 or more. Moreover, it is preferred that the particles have the refractive index of 1.70 or less, more preferably 1.65 or less. When the refractive index falls within the range described above, the ink has a refractive index which is less liable to be lower than that of a binder resin (for example, acrylic monomer described later), and is likely to attain the matting effect. Moreover, a coating film on an obtained printed matter is less liable to cause cloudiness. In the present embodiment, the refractive index of the particles can be measured, for example, through use of an Abbe refractometer (KPR-30A, manufactured by Shimadzu Corporation) by placing particles on a prism.

It is preferred that the particles have the specific gravity of 2.1 or less, more preferably 2.0 or less. A lower limit of the specific gravity of the particles is not particularly limited. When the specific gravity of the particles falls within the range described above, the particles are less liable to sink at the time of forming the coating film, and a desired matting effect is likely to be attained. In the present embodiment, the specific gravity of the particles represents a true specific gravity and can be measured through use of a specific gravity bottle (pycnometer) of a Gay-Lussac type.

A content of the particles is not particularly limited. For example, it is preferred that the content of the particles in the ink be 0.5 mass % or more, more preferably 1 mass % or more, further preferably 2 mass % or more. Moreover, it is preferred that the content of the particles in the ink be 15 mass % or less, more preferably 12 mass % or less, further preferably 10 mass % or less. When the content of the particles falls within the range described above, the ink is likely to attain a desired matting effect. Moreover, the ink is excellent in storage stability, and an obtained coating film is less liable to cause, for example, cloudiness.

### Other Components

In addition to the particles described above, the ink of the present embodiment may suitably include a binder resin, a dispersant, a solvent, and various optional components.

The binder resin is favorably blended, for example, to adjust the viscosity of the ink, adjust the hardness of the obtained printed matter, and control the shape thereof.

A kind of the binder resin is not particularly limited. Examples of the binder resin include an epoxy resin, a diallyl phthalate resin, a silicone resin, a phenol resin, an unsaturated polyester resin, a polyimide resin, a polyurethane resin, a melamine resin, a urea resin, an ionomer resin, an ethylene ethyl acrylate resin, an acrylonitrile acrylate styrene copolymer resin, an acrylonitrile styrene resin, an acrylonitrile chlorinated polyethylene styrene copolymer resin, an ethylene-vinyl acetate resin, an ethylene-vinyl alcohol copolymer resin, an acrylonitrile butadiene styrene copolymer resin, a vinyl chloride resin, a chlorinated polyethylene resin, a polyvinylidene chloride resin, a cellulose acetate resin, a fluorine resin, a polyoxymethylene resin, a polyamide resin, a polyarylate resin, a thermoplastic polyurethane elastomer, a polyetheretherketone resin, a polyether sulfone resin, polyethylene, polypropylene, a polycarbonate resin, polystyrene, a polystyrene maleic acid copolymer resin, a polystyrene acrylic acid copolymer resin, a polyphenylene ether resin, a polyphenylene sulfide resin, a polybutadiene resin, a polybutylene terephthalate resin, an acrylic resin, a methacrylic resin, a methyl pentene resin, a polylactic acid, a polybutylene succinate resin, a butyral resin, a formal resin, a polyvinyl alcohol, polyvinylpyrrolidone, ethyl cellulose, carboxymethyl cellulose, gelatin, and a copolymer resin thereof. The binder resin may suitably be selected in consideration of film strength, viscosity, remainder viscosity of an inkjet ink, dispersion stability of a pigment, thermal stability, non-coloring property, water resistance, and chemical resistance. The binder resins may be used in combination.

The fluorine resin is not particularly limited. For example, it is preferred that the fluorine resin be a copolymer including a fluorine-containing monomer and a vinyl monomer. Moreover, it is more preferred that the fluorine resin be a copolymer with a vinyl ether monomer among the vinyl monomers. Further, it is more preferred that the fluorine resin be a copolymer including fluoroethylene and a vinyl ether monomer.

A weight-average molecular weight (Mw) of the fluorine resin is not particularly limited. For example, it is preferred that the Mw be 5,000 or more, more preferably 8,000 or more. It is preferred that the Mw be 50,000 or less, more preferably 40,000 or less. When the Mw falls within the range described above, the fluorine resin is likely to be dissolved in a solvent. Moreover, the obtained ink is improved in drying characteristics, and is excellent in ejection stability at the time of inkjet printing. When the Mw is less than 5,000, the obtained printed matter is liable to cause stickiness, and is liable to be degraded in blocking prevention characteristics. Meanwhile, when the Mw is more than 50,000, the fluorine resin is liable to be degraded in solubility, and the ejection stability of the ink at the time of inkjet printing is liable to be degraded. In the present embodiment, the Mw and a number-average molecular weight (Mn), which is described later, are values measured by gel permeation chromatography (GPC), and may be measured through use of a high-speed GPC device (HLC-8120GPC, manufactured by TOSOH CORPORATION).

The acrylic resin is not particularly limited. Examples of the acrylic resin include polymers of an acrylic acid ester (acrylate) or a methacrylic acid ester (methacrylate). More specifically, examples of the acrylic resin include polymers including: acrylic acid alkyl esters such as methyl acrylate, ethyl acrylate, propyl acrylate, butyl acrylate, isobutyl acrylate, and 2-ethylhexyl acrylate; methacrylic acid alkyl esters such as methyl methacrylate, ethyl methacrylate, propyl methacrylate, butyl methacrylate, isobutyl methacrylate, and 2-ethylhexyl methacrylate; hydroxy group-containing acrylic acid esters such as 2-hydroxyethyl acrylate, 2-hydroxypropyl acrylate, and 2-hydroxybutyl acrylate; and hydroxy group-containing methacrylic acid esters such as 2-hydroxyethyl methacrylate, 2-hydroxypropyl methacrylate, and 4-hydroxybutyl methacrylate. Those may be used in combination.

The weight-average molecular weight (Mw) of the acrylic resin is not particularly limited. For example, it is preferred that the Mw be 5,000 or more, more preferably 10,000 or more. It is preferred that the Mw be 100,000 or less, more preferably 50,000 or less. When the Mw falls within the range described above, the ink including such acrylic resin is excellent in ejection stability at the time of inkjet printing.

The vinyl chloride resin is not particularly limited. Examples of the vinyl chloride resin include a copolymer including vinyl chloride and other monomer such as vinyl acetate, vinylidene chloride, acrylic acid, maleic acid, or vinyl alcohol. Among those, it is preferred that the vinyl chloride resin be a copolymer including a constituting unit originating from the vinyl chloride and the vinyl acetate (vinyl chloride-vinyl acetate copolymer).

The vinyl chloride-vinyl acetate copolymer can be obtained, for example, by suspension polymerization. It is preferred that the vinyl chloride-vinyl acetate copolymer contain the vinyl chloride unit by 70 mass % to 90 mass %. Within the range described above, the vinyl chloride-vinyl acetate copolymer is stably dissolved in the ink, and thus is excellent in long-term preservation stability. Moreover, the obtained ink is excellent in ejection stability.

The vinyl chloride-vinyl acetate copolymer may include other constituting units in addition to the vinyl chloride unit and the vinyl acetate unit, as needed. Examples of other constituting units include a carboxylic acid unit, a vinyl alcohol unit, and a hydroxyalkyl acrylate unit. Among those, it is preferred that other constituting unit be the vinyl alcohol unit.

The number-average molecular weight (Mn) of the vinyl chloride resin is not particularly limited. For example, it is preferred that the Mn of the vinyl chloride resin be 10,000 or more, more preferably 12,000 or more. Moreover, it is preferred that the Mn be 50,000 or less, more preferably 42,000 or less. The Mn can be measured by the GPC and can be determined as a relative value by conversion in terms of polystyrene.

The silicone resin is not particularly limited. Examples of the silicone resin include a methyl-based straight silicone resin (polydimethyl siloxane), a methylphenyl-based straight silicone resin (polydimethyl siloxane in which part of a methyl group is substituted with a phenyl group), an acrylic resin-modified silicone resin, a polyester resin-modified silicone resin, an epoxy resin-modified silicone resin, an alkyd resin-modified silicone resin, and a rubber-based silicone resin. Those may be used in combination. Among those, it is preferred that the silicone resin be the methyl-based straight silicone resin, the methylphenyl-based straight silicone resin, or the acrylic resin-modified silicone resin.

The silicone resin may be obtained by being dissolved in, for example, an organic solvent. Examples of the organic solvent include xylene and toluene.

The number-average molecular weight (Mn) of the silicone resin is not particularly limited. For example, it is preferred that the Mn of the silicone resin be 10,000 or more, more preferably 20,000 or more. Moreover, it is preferred that the Mn be 5,000,000 or less, more preferably 3,000,000 or less. The Mn can be measured by the GPC and can be determined as a relative value by conversion in terms of polystyrene.

Now returning to the overall description of the binder resin, the content of the binder resin is not particularly limited. For example, it is preferred that the content of the binder resin in the ink by conversion in terms of solid content be 1 mass % or more, more preferably 3 mass % or more, further preferably 5 mass % or more. Moreover, it is preferred that the content of the binder resin in the ink be 40 mass % or less, more preferably 30 mass % or less, further preferably 25 mass % or less. When the content of the binder resin is less than 1 mass %, desired performance as a binder is less likely to be obtained, and adhesion to the base material is liable to be degraded. Meanwhile, when the content of the binder resin is more than 40 mass %, the viscosity of the ink increases, and the ejection stability at the time of inkjet printing is liable to be degraded.

### Dispersant

The dispersant is favorably blended for dispersion of the pigment. The dispersant is not particularly limited. Examples of the dispersant include an anionic surfactant, a nonionic surfactant, and a polymeric dispersant. Those may be used in combination.

Examples of the anionic surfactant include fatty acid salt, alkyl sulfuric acid ester salt, alkyl benzene sulfonate, alkyl naphthalene sulfonate, lignin sulfonate, dialkyl sulfosuccinic acid salt, alkyl phosphate ester salts, naphthalene sulfonic acid formalin condensate, polyoxyethylene alkyl sulfuric acid ester salt, and substituted derivatives thereof.

Examples of the nonionic surfactant include a polyoxyethylene alkyl ether, a polyoxyethylene alkyl phenyl ether, a polyoxyethylene fatty acid ester, a sorbitan fatty acid ester, a polyoxyethylene sorbitan fatty acid ester, a polyoxyethylene alkyl amine, a glycerin fatty acid ester, an oxyethylene oxypropylene block polymer, and substituted derivatives thereof.

In view of obtaining more stable dispersion characteristics, it is preferred that the polymeric dispersant have both an acid value and a base value, and that the acid value be larger than the base value. Examples of the polymeric dispersant include PB series manufactured by Ajinomoto Fine-Techno Co., Inc., Hinoacto series manufactured by Kawaken Fine Chemicals Co., Ltd., Solsperse series manufactured by Lubrizol Japan Limited, DISPARLON series manufactured by Kusumoto Chemicals, Ltd., and Efka (registered trademark) series manufactured by BASF Japan.

A content of the dispersant is suitably determined based on a kind of a pigment to be dispersed and a content thereof. For example, it is preferred that the content of the dispersant, with respect to the pigment being 100 parts by mass, be 5 parts by mass or more, more preferably 10 parts by mass or more. Moreover, it is preferred that the content of the dispersant, with respect to the pigment being 100 parts by mass, be 150 parts by mass or less, more preferably 80 parts by mass or less. When the content of the dispersant is less than 5 parts by mass, the pigment is less likely to be dispersed. Meanwhile, when the content of the dispersant is more than 150 parts by mass, a raw material cost is liable to increase, or dispersion of the pigment is liable to be hindered.

### Solvent

The solvent is a liquid component for dissolving the binder resin in the ink constituting the ink set. A kind of the solvent is not particularly limited. Examples of the solvent include water, a glycol ether-based solvent, an acetate-based solvent, an alcohol-based solvent, a ketone-based solvent, an ester-based solvent, a hydrocarbon-based solvent, a fatty acid ester-based solvent, and an aromatic solvent. Those may be used in combination. Among those, it is preferred that the solvent of the present embodiment include at least any one of the glycol ether-based solvent and the acetate-based solvent. The glycol ether-based solvent and the acetate-based solvent have a low viscosity and a relatively high boiling point. Therefore, the ink including those as the solvent is more improved in drying characteristics and is more excellent in ejection stability at the time of inkjet printing.

Examples of the glycol ether-based solvent include an ethylene glycol monomethyl ether, an ethylene glycol monoethyl ether, an ethylene glycol mono(iso)propyl ether, an ethylene glycol monobutyl ether, a diethylene glycol monoethyl ether, a diethylene glycol mono-n-butyl ether, a propylene glycol monomethyl ether, a propylene glycol monoethyl ether, a propylene glycol mono-n-propyl ether, a propylene glycol mono-n-butyl ether, a dipropylene glycol monomethyl ether, a dipropylene glycol monoethyl ether, a dipropylene glycol mono-n-propyl ether, a dipropylene glycol mono-n-butyl ether, a triethylene glycol monomethyl ether, a triethylene glycol monoethyl ether, a triethylene glycol mono-n-propyl ether, a triethylene glycol mono-n-butyl ether, a tripropylene glycol monoethyl ether, a tripropylene glycol mono-n-propyl ether, a tripropylene glycol mono-n-butyl ether, a diethylene glycol dimethyl ether, a triethylene glycol dimethyl ether, a tetraethylene glycol dimethyl ether, a polyethylene glycol dimethyl ether, a diethylene glycol diethyl ether, a diethylene glycol dibutyl ether, a diethylene glycol ethyl methyl ether, a diethylene glycol isopropyl methyl ether, a diethylene glycol butyl methyl ether, a triethylene glycol butyl methyl ether, a dipropylene glycol dimethyl ether, and a tripropylene glycol dimethyl ether.

Examples of the acetate-based solvent include: alkylene glycol monoalkyl ether acetates such as ethylene glycol monomethyl ether acetate, ethylene glycol monoethyl ether acetate, ethylene glycol monopropyl ether acetate, ethylene glycol monoisopropyl ether acetate, ethylene glycol mono-n-butyl ether acetate, ethylene glycol mono-sec-butyl ether acetate, ethylene glycol monoisobutyl ether acetate, ethylene glycol mono-tert-butyl ether acetate, propylene glycol monomethyl ether acetate, propylene glycol monoethyl ether acetate, propylene glycol monoisopropyl ether acetate, propylene glycol monopropyl ether acetate, propylene glycol mono-n-butyl ether acetate, propylene glycol mono-sec-butyl ether acetate, propylene glycol monoisobutyl ether acetate, propylene glycol mono-tert-butyl ether acetate, 3-methyl-3-metoxybutyl acetate, 3-methyl-3-etoxybutyl acetate, 3-methyl-3-propoxybutyl acetate, 3-methyl-3-isopropoxybutyl acetate, 3-methyl-3-n-butoxyethyl acetate, 3-methyl-3-isobutoxybutyl acetate, 3-methyl-3-sec-butoxybutyl acetate, and 3-methyl-3-tert-butoxybutyl acetate; ethylene glycol diacetate; diethylene glycol diacetate; triethylene glycol diacetate; propylene glycol diacetate; dipropylene glycol diacetate; and tripropylene glycol diacetate.

It is preferred that the solvent of the present embodiment have a boiling point of 150° C. or more, more preferably 180° C. or more. Moreover, it is preferred that the solvent have the boiling point of 300° C. or less, more preferably 280° C. or less. When the boiling point falls within the range described above, the obtained ink is more improved in drying characteristics, and is more excellent in ejection stability at the time of inkjet printing. Moreover, with the ink, a clear printed matter with less blur is likely to be formed. When the solvent has the boiling point of less than 150° C., the ink is more liable to be dried in a periphery of a head nozzle and is more liable to be degraded in ejection stability. Meanwhile, when the solvent has the boiling point of more than 300° C., the ink is less likely to be dried, and more time is liable to be taken in the drying step at the time of formation of the printed matter. Moreover, an image is more liable to be blurred in the obtained printed matter.

A content of the solvent is not particularly limited. For example, it is preferred that the content of the solvent in the ink be 50 mass % or more, more preferably 60 mass % or more. Moreover, it is preferred that the content of the solvent in the ink be 99 mass % or less, more preferably 80 mass % or less. When the content of the solvent is less than 50 mass %, the viscosity of the ink becomes higher, and the ejection stability at the time of the inkjet printing is liable to be degraded. Meanwhile, when the content of the solvent is more than 99 mass %, the ratio of the binder resin that can be added to the ink becomes smaller, and the desired performance is less likely to be obtained.

### Optional Components

The ink of the present embodiment may suitably include optional components blended therein in addition to the components described above. Examples of the optional components include a heat stabilizer, an antioxidant, an antiseptic, an antifoamer, a penetrant, a reduction inhibitor, a leveling agent, a pH conditioner, a polymerization inhibitor, an ultraviolet absorber, and a light stabilizer.

Moreover, a kind of the ink of the present embodiment may be a radical polymerization-type ultraviolet curable ink or a cationic polymerization-type ultraviolet curable ink. In the cases of those inks, the following components may be further included in addition to the components described above.

### Radical Polymerization-Type Ultraviolet Curable Inkjet Ink

In the case of the radical polymerization-type ink, the ink mainly includes a reactive monomer, a reactive oligomer, and a photopolymerization initiator in addition to the particles described above. When the ink is of the radical polymerization type, the ink is less expensive as compared to the ink of the cationic polymerization type, and a larger amount of a material therefor is available in the market. Thus, the ink can easily be designed.

The reactive monomer is not particularly limited. Examples of the reactive monomer include aromatic vinyl monomers, vinyl ester monomers, vinyl ethers, allylic compounds, (meth)acrylamides, and (meth)acrylates. More specifically, examples of the reactive monomer include: aromatic vinyl monomers such as styrene, a-methyl styrene, a-chlorostyrene, vinyl toluene, and divinyl benzene; vinyl ester monomers such as vinyl acetate, vinyl butyrate, N-vinyl formamide, N-vinyl acetamide, N-vinyl 2-pyrrolidone, N-vinyl caprolactam, and divinyl adipate; vinyl ethers such as an ethyl vinyl ether and a phenyl vinyl ether; allyl compounds such as diallyl phthalate, a trimethylolpropane diallyl ether, and an allyl glycidyl ether; (meth)acrylamides such as acrylamide, N,N-dimethyl acrylamide, N,N-dimethyl methacrylamide, N-methylol acrylamide, N-methoxymethyl acrylamide, N-butoxymethyl acrylamide, N-t-butyl acrylamide, acryloylmorpholine, and methylenebisacrylamide; monofunctional (meth)acrylates such as (meth)acrylate, methyl (meth)acrylate, ethyl (meth)acrylate, propyl (meth)acrylate, n-butyl (meth)acrylate, i-butyl (meth)acrylate, t-butyl (meth)acrylate, hexyl (meth)acrylate, 2-ethylhexyl (meth)acrylate, lauryl (meth)acrylate, stearyl (meth)acrylate, tetrahydrofurfuryl (meth)acrylate, morphoryl (meth)acrylate, 2-hydroxyethyl (meth)acrylate, 2-hydroxypropyl (meth)acrylate, 4-hydroxybutyl (meth)acrylate, glycidyl (meth)acrylate, dimethylaminoethyl (meth)acrylate, diethylaminoethyl (meth)acrylate, benzyl (meth)acrylate, cyclohexyl (meth)acrylate, phenoxyethyl (meth)acrylate, tricyclodecane (meth)acrylate, dicyclopentenyl (meth)acrylate, dicyclopentenyl oxyethyl (meth)acrylate, dicyclopentanyl (meth) acrylate, allyl (meth)acrylate, 2-ethoxyethyl (meth)acrylate, isobornyl (meth)acrylate, acrylic acid=(2-ethyl-2-methyl-1,3-dioxolan-4-yl) methyl, tetrahydrofurfuryl acrylate, and phenyl (meth)acrylate; and multifunctional (meth)acrylates such as ethylene glycol di(meth)acrylate, diethylene glycol di(meth)acrylate, triethylene glycol di(meth)acrylate, tetraethylene glycol di(meth)acrylate, polyethylene glycol di(meth)acrylate (n=5 to 14), propylene glycol di(meth)acrylate, dipropylene glycol di(meth)acrylate, tripropylene glycol di(meth)acrylate, tetrapropylene glycol di(meth)acrylate, polypropylene glycol di(meth)acrylate (n=5 to 14), 1,3-butylene glycol di(meth)acrylate, 1,4-butanediol di(meth)acrylate, polybutylene glycol di(meth)acrylate (n=3 to 16), poly(1-methyl butylene glycol) di(meth)acrylate (n=5 to 20), 1,6-hexanediol di(meth)acrylate, 1,9-nonanediol di(meth)acrylate, neopentyl glycol di(meth)acrylate, hydroxypivalate neopentyl glycol di(meth)acrylate ester, dicyclopentanediol di(meth)acrylate, tricyclodecane di(meth)acrylate, trimethylol propane tri(meth)acrylate, pentaerythritol tri(meth)acrylate, pentaerythritol tetra(meth)acrylate, ditrimethylol propane tetra(meth)acrylate, dipentaerythritol tetra(meth)acrylate, dipentaerythritol penta(meth)acrylate, dipentaerythritol hexa(meth)acrylate, trimethylol propane trioxyethyl (meth)acrylate, trimethylol propane trioxypropyl (meth)acrylate, trimethylol propane polyoxyethyl (meth)acrylate, trimethylol propane polyoxypropyl (meth)acrylate, tris(2-hydroxyethyl)isocyanurate tri(meth)acrylate, tris(2-hydroxyethyl)isocyanurate di(meth) acrylate, ethyleneoxide adduct bisphenol A di(meth)acrylate, ethylene oxide adduct bisphenol F di(meth)acrylate, propylene oxide adduct bisphenol A di(meth)acrylate, propylene oxide adduct bisphenol F di(meth)acrylate, tricyclodecanedimethanol di(meth)acrylate, bisphenol A epoxy di(meth)acrylate, and bisphenol F epoxy di(meth)acrylate. Those reactive monomers may be used in combination. Among those, it is preferred that the reactive monomer be acrylic acid=(2-ethyl-2-methyl-1,3-dioxolan-4-yl) methyl or tetrahydrofurfuryl acrylate from a point that those reactive monomers have a relatively low viscosity.

A content of the reactive monomer is not particularly limited. For example, it is preferred that the content of the reactive monomer in the ink be 50 mass % or more, more preferably 70 mass % or more. Moreover, it is preferred that the content of the reactive monomer in the ink be 95 mass % or less, more preferably 90 mass % or less. When the content of the reactive monomer falls within the range described above, the ink is likely to exhibit a suitable curability. Moreover, the ink can easily be adjusted to an appropriate viscosity and is excellent in ejection stability at the time of inkjet printing.

The reactive oligomer is not particularly limited. Examples of the reactive oligomer include urethane acrylate, polyester acrylate, epoxy acrylate, silicon acrylate, and polybutadiene acrylate. Among those, it is preferred that the reactive oligomer be urethane acrylate from a point that the urethane acrylate is excellent in toughness, adhesion, and flexibility. More specifically, it is preferred that the reactive oligomer be aliphatic urethane acrylate. Those reactive oligomers may be used in combination.

A content of the reactive oligomer is not particularly limited. For example, it is preferred that the content of the reactive oligomer in the ink be 2 mass % or more, more preferably 5 mass % or more. Moreover, it is preferred that the content of the reactive oligomer in the ink be 40 mass % or less, more preferably 30 mass % or less. When the content of the reactive oligomer falls within the range described above, the obtained ink is likely to be appropriately adjusted in toughness, adhesion, and flexibility. Moreover, the ink is likely to be adjusted to an appropriate viscosity, and hence is excellent in ejection stability at the time of inkjet printing.

The photopolymerization initiator is not particularly limited. Examples of the photopolymerization initiator include benzoins, benzyl ketals, amino ketones, titanocenes, bisimidazoles, hydroxy ketones, and acylphosphine oxides. The photopolymerization initiators may be used in combination. Among those, it is preferred that the photopolymerization initiator be hydroxyl ketones or acylphosphine oxides from a point that those photopolymerization initiators are highly reactive and less liable to be yellowed.

A content of the photopolymerization initiator is not particularly limited. For example, it is preferred that the content of the photopolymerization initiator in the ink be 1 mass % or more, more preferably 2 mass % or more. Moreover, it is preferred that the content of the photopolymerization initiator in the ink be 15 mass % or less, more preferably 12 mass % or less. When the content of the photopolymerization initiator falls within the range described above, the ink is likely to be cured at an appropriate curing rate and curing speed.

The radical polymerization-type ink may be blended, as needed, with a dispersion assist agent, a sensitizer, a heat stabilizer, an antioxidant, an antiseptic, an antifoamer, a resin binder, a resin emulsion, a reduction inhibitor, a leveling agent, a pH conditioner, a pigment derivative, a polymerization inhibitor, an ultraviolet absorber, and a light stabilizer. In particular, it is preferred that the ink of the present embodiment include (meth)acrylic silane as the dispersion assist agent.

The (meth)acrylic silane is not particularly limited as long as it is a compound including a (meth)acrylic group ((meth)acryloxy group or (meth)acryloyloxy group) and a hydrolyzable silyl group. The (meth)acrylic group and the hydrolyzable silyl group can be bonded to each other through an organic group. The (meth)acrylic group can be bonded to the organic group through oxygen atoms. In this case, the (meth)acrylic group is a (meth)acryloyl group. The organic group may be an aliphatic hydrocarbon group (aliphatic hydrocarbon group may be in a chain form, a branch form, an annular form, and combinations thereof), an aromatic hydrocarbon group, or a combination thereof. The organic group may include heteroatoms such as oxygen atoms, nitrogen atoms, and sulfur atoms. The hydrolyzable silyl group is, for example, a methyldimethoxysilyl group, a methyldiethoxysilyl group, trimethoxysilyl group, or a triethoxysilyl group.

Examples of the (meth)acrylic silane include
3-methacryloxypropylmethyldimethoxysilane,
3-methacryloxypropyltrimethoxysilane,
3-methacryloxypropylmethyldiethoxysilane,
3-methacryloxypropyltriethoxysilane, and
3-acryloxypropyltrimethoxysilane.

The (meth)acrylic silane may react, in the ink, with a hydroxyl group which partially remain on the particles (for example, melamine beads). The particles obtained after the reaction is excellent in compatibility with the reactive monomer described above. Therefore, the ink of the present embodiment including the (meth)acrylic silane can reduce reaggregation of the particles in the ink, and hence the storage stability of the ink is more likely to be improved.

A content of the (meth)acrylic silane is not particularly limited. For example, it is preferred that the content of the (meth)acrylic silane in the ink be 0.01 mass % or more, more preferably 0.02 mass % or more. Moreover, it is preferred that the content of the (meth)acrylic silane in the ink be 5 mass % or less, more preferably 1 mass % or less. When the content of the (meth)acrylic silane falls within the range described above, the ink is likely to be improved in compatibility of the particles and is likely to be improved in storage stability. The (meth)acrylic silane is particularly useful when the melamine beads are included as the particles. That is, the melamine beads are improved in compatibility with, for example, an acrylic monomer by the (meth)acrylic silane. As a result, the ink is more excellent in storage stability.

It is preferred that a blend ratio (mass ratio) of the (meth)acrylic silane and the melamine beads be 1:10 to 1:200, more preferably 1:20 to 1:200, further preferably 1:50 to 1:200. When the blend ratio falls within the range described above, the melamine beads are improved in compatibility with, for example, the acrylic monomer by the (meth)acrylic silane. As a result, the ink is more excellent in storage stability.

### Cationic Polymerization-Type Ultraviolet Curable Inkjet Ink

In a case of a cationic polymerization-type ink, the ink mainly includes a dispersant, a cationic polymerizable compound, and photopolymerization initiator in addition to the particles described above.

The cationic polymerizable compound is not particularly limited. Examples of the cationic polymerizable compound include aromatic epoxide, cycloaliphatic epoxide, and aliphatic epoxide. Examples of the aromatic epoxide include a di- or polyglycidyl ether of bisphenol A or an alkylene oxide adduct thereof, a di- or polyglycidyl ether of hydrogenated bisphenol A or an alkylene oxide adduct thereof, and a novolac epoxy resin. Examples of the cycloaliphatic epoxide include compounds containing cyclohexane oxide or cyclopentane oxide, which can be obtained through epoxidation of a compound having at least one cyclohexane or a cycloalkane ring such as a cyclopentane ring with an oxidant such as hydrogen peroxide or peracid. Examples of the aliphatic epoxide include: a diglycidyl ether of alkyleneglycol such as a diglycidyl ether of ethylene glycol, a diglycidyl ether of propylene glycol, or a diglycidyl ether of 1,6-hexanediol; a polyglycidyl ether of a polyalcohol such as a di- or triglycidyl ether of glycerin or an alkylene oxide adduct thereof; and a diglycidyl ether of polyalkylene glycol such as a diglycidyl ether of polyethylene glycol or an alkylene oxide adduct thereof or a diglycidyl ether of polypropylene glycol or an alkylene oxide adduct thereof.

A content of the cationic polymerizable compound is not particularly limited. For example, it is preferred that the content of the cationic polymerizable compound in the ink be 50 mass % or more, more preferably 70 mass % or more. Moreover, it is preferred that the content of the cationic polymerizable compound in the ink be 95 mass % or less, more preferably 90 mass % or less. When the content of the cationic polymerizable compound falls within the range described above, the ink is excellent in curability of an obtained coating film.

The photopolymerization initiator is not particularly limited. Examples of the photopolymerization initiator include acetophenone, 2,2-diethoxyacetophenone, p-dimethylaminoacetophenone, p-dimethylaminopropiophenone, benzophenone, 2-chlorobenzophenone, pp′-dichlorobenzophenone, pp′-bisdiethylaminobenzophenone, Michler's ketone, benzyl, benzoin, a benzoin methyl ether, a benzoin ethyl ether, a benzoin isopropyl ether, a benzoin n-propyl ether, a benzoin isobutyl ether, a benzoin n-butyl ether, benzyl dimethylketal, tetramethylthiuram monosulfide, thioxanthone, 2-chlorothioxanthone, 2-methylthioxanone, azobisisobutyronitrile, benzoin peroxide, di-tert-butyl peroxide, 1-hydroxycyclohexyl phenyl ketone, 2-hydroxy-2-methyl-1-phenyl-1-on, 1-(4-isopropylphenylphenyl)- 2-hydroxy-2-methylpropane-1-on, and methylbenzoyl formate.

A content of the photopolymerization initiator is not particularly limited. For example, it is preferred that the content of the photopolymerization initiator in the ink be 1 mass % or more, more preferably 2 mass % or more. Moreover, it is preferred that the content of the photopolymerization initiator in the ink be 15 mass % or less, more preferably 12 mass % or less. When the content of the photopolymerization initiator falls within the range described above, the ink is excellent in curability of an obtained coating film.

Returning to the overall description of the ink, a viscosity of the ink is not particularly limited. For example, it is preferred that the viscosity of the ink be 2 mPa·s or more, more preferably 5 mPa·s or more. Moreover, it is preferred that the viscosity be 50 mPa·s or less, more preferably 30 mPa·s or less. When the viscosity falls within the range described above, the ink is less liable to cause a failure of discharging from the inkjet head and is excellent in ejection stability. In the present embodiment, the viscosity of the ink can be measured through use of a B-type viscometer (TVB-20LT manufactured by TOKI SANGYO CO., LTD., rotor rotation number: 60 rpm, rotor No. M1).

A method of adjusting the viscosity to fall within the range described above is not particularly limited. For example, the viscosity may be adjusted depending on an amount of each component to be added and a kind and an amount of the solvent to be used. The viscosity may be adjusted through use of a viscosity modifier such as a thickener as needed.

A surface tension of the ink is not particularly limited. It is preferred that the surface tension of the ink at 25° C. be 20 dyne/cm or more, more preferably 22 dyne/cm or more. Moreover, it is preferred that the surface tension of the ink at 25° C. be 40 dyne/cm or less, more preferably 35 dyne/cm or less. When the surface tension falls within the range described above, the ink is excellent in ejection stability. In the present embodiment, the surface tension can be measured through use of a static surface tension meter (plate method) (CBVP-A3 manufactured by Kyowa Interface Science Co., Ltd.).

The ink of the present embodiment is ejected onto the base material through use of an inkjet device adopting an inkjet method so that the ink can be applied to the base material. With this, a region to which the ink is applied (first region, second region, or both) is formed on the base material. A size of an ink droplet is not particularly limited. For example, the size of the droplet is about 50 to 100 μm. A degree of matteness (gloss value) may easily be adjusted by adjusting a composition (for example, the particles described above) of the ink or a density of droplets of the ink on the base material.

### (First Region and Second Region)

The first region and the second region are regions formed on the formed body according to the present embodiment and have gloss values different from each other. At least any one of the first region and the second region is a region to which the ink described above is applied. As described above, the formed base material is only required to have a three-dimensional shape formed in accordance with a desired use, and the base material may have one or a plurality of curved surfaces or a surface other than the curved surface (non-curved surface such as a flat surface). In the following, description is made of examples of a formed body having the first region and the second region formed thereon.

Specific Example 1 of Formed Body (Example in which the Formed Body has a Plurality of Curved Surfaces and the Ink is Applied to One Region)

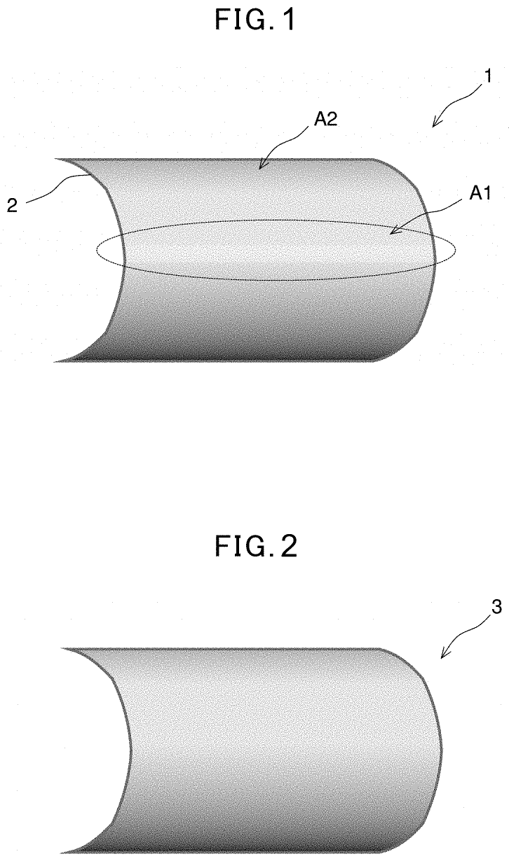

FIG. 1 is a schematic perspective view for illustrating a formed body 1 according to the present embodiment. FIG. 1 shows an example of the formed body 1 in which a plate-like base material 2 is bent into an arc shape. The formed body 1 illustrated in FIG. 1 has such a shape that the formed body 1 is curved to protrude toward a front side on the drawing sheet. The formed body 1 has a region which is significantly bent in the vicinity of the center of the base material 2 (first region A1, first curved surface) and a region which is located around the first region A1 and is curved more gently than the first region A1 (second region A2, second curved surface). As illustrated in FIG. 1, the second region A2 is a region to which the ink is applied, and the matteness is given. Meanwhile, the first region A1 is not a region to which the ink is applied, and is the base material 2 itself. Therefore, the matteness is not given to the first region A1.

FIG. 2 is a schematic perspective view for illustrating a related-art formed body 3 to which the inkjet ink of the present embodiment is not applied. In the formed body 3 illustrated in FIG. 2, the ink is not applied to the region corresponding to the second region A2 illustrated in FIG. 1.

As illustrated in FIG. 1, in the formed body according to the present embodiment, the curved surface having a larger degree of a curve corresponds to the first region A1 to which the ink is not applied. With this, the formed body 1 is adjusted so that the gloss value in the first region A1 is larger than the gloss value in the second region A2 therearound. As a result, as compared to the formed body 3 illustrated in FIG. 2, the formed body 1 can exert such a visual effect that a curve having a degree of a curve larger than the actual curve is given to the first region A1. Such a visual effect is useful particularly for a use in which the shape of the formed body 1 is limited (for example, use such as interior component of automobile), use such as an interior component of transport means other than the automobile (for example, bus, train, or aircraft), and use for interior materials such as furniture or housing materials such as building materials. That is, in some cases, for example, an interior component of an automobile is limited in shape of the formed body for the purpose of securing a cabin space. In such a case, it is sometimes difficult to give a desired degree of a curve to the formed body. However, even in such a case, the formed body 1 according to the present embodiment may give an observer such a visual effect that a degree of a curve larger than the actual degree of a curve is given to the formed body 1. As a result, the formed body 1 may exhibit more excellent external appearance while satisfying limitation on the shape.

In such a formed body, it is preferred that a difference in gloss value (AG) between the first region and the second region be 0.5 or more. Moreover, it is preferred that the difference in gloss value (AG) be 95 or less. When the difference in gloss value (AG) falls within the range described above, a wide variety of designs may be given to the formed body based on the difference in matteness.

Specific Example 2 of Formed Body (Example in which the Formed Body has a Curved Surface and a Non-Curved Surface and in which the Ink is Applied to One Region)

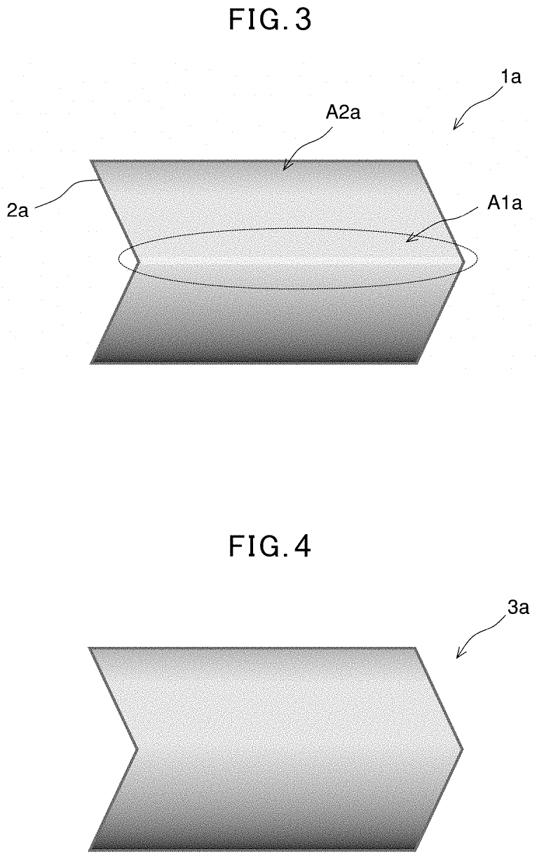

FIG. 3 is a schematic perspective view for illustrating a formed body la according to the present embodiment. FIG. 3 shows an example of the formed body la in which a base material 2a having a flat plate shape is bent at a center thereof. The formed body la illustrated in FIG. 3 has such a shape that the formed body la is bent to protrude toward the front side on the drawing sheet. The formed body 1a has a region which is bent in the vicinity of the center of the base material 2a (first region A1a) and a region which is located around the first region Ala and has a flat shape which is not bent (second region A2a, non-curved surface). As illustrated in FIG. 3, the first region A1a is a region to which the ink is not applied, and is the base material 2a itself to which the matteness is not given. Meanwhile, the second region A2a is a region to which the ink is applied and to which the matteness is given. The gloss values of the first region A1a and the second region A2a are the same as those described above.

FIG. 4 is a schematic perspective view for illustrating a related-art formed body 3a to which the inkjet ink of the present embodiment is not applied. In the formed body 3a illustrated in FIG. 4, the ink is not applied to the region corresponding to the second region A2a illustrated in FIG. 3.

In the formed body according to the present embodiment, as illustrated in FIG. 3, the ink is applied to the region around the bent curved surface as the second region A2a. With this, the formed body 1a is adjusted so that a gloss value in the second region A2a becomes smaller than a gloss value in the first region A1a. As a result, the formed body 1a can exert such a visual effect that, as compared to the formed body 3a illustrated in FIG. 4, the formed body la is bent in the first region Ala sharper than an actual degree of the curve. Such a visual effect is useful in use that the shape of the formed body la is limited as described above.

Specific Example 3 of Formed Body (Example in which the Formed Body has a Plurality of Curved Surfaces and the Ink is Applied to a Plurality of Regions)

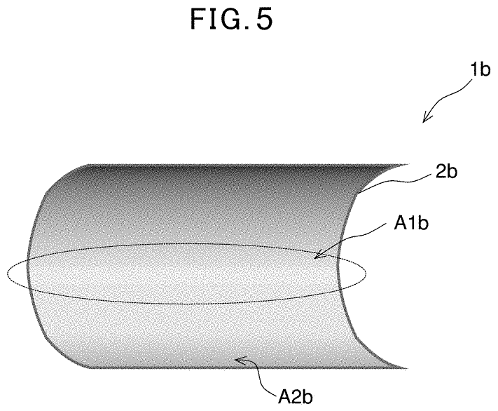

In the Specific example 1 and the Specific example 2 described above, description is made of the example case in which, in the formed body having such a curved shape protruding toward the near side on the drawing sheet, the ink is not applied in the vicinity of the center of the base material, and the ink is applied only the second region therearound. The formed body according to the present embodiment is only required to have different gloss values in the first region and the second region. Therefore, the ink may be applied not only to the second region but also to the first region of the formed body. Moreover, the formed body may be a formed body having such a curved shape of protruding toward a far side on the drawing sheet. FIG. 5 is a schematic perspective view for illustrating a formed body 1b according to the present embodiment. FIG. 5 shows an example of the formed body lb in which a base material 2b having a flat plate shape is bent into an arc shape. The formed body lb illustrated in FIG. 5 has such a curved shape protruding toward the far side on the drawing sheet. The formed body lb includes a region of being bent significantly in the vicinity of the center of the base material 2b (first region A1b) and a region which is around the first region A1b and has a degree of a curve gentler than the first region A1b (second region A2). As illustrated in FIG. 5, the first region A1b and the second region A2b are each a region in which the ink is applied, and the matteness is given. However, a gloss value of the first region A1b is larger than a gloss value of the second region A2b. Therefore, in the formed body lb, the glossiness in the vicinity of the center is more emphasized. The gloss values of the first region A1b and the second region A2b are the same as those described above.

In the Specific examples 1 to 3, illustration is given of the example cases in which the glossiness of the region in the vicinity of the center is emphasized (see FIG. 1, FIG. 3, and FIG. 5). Instead, the formed body may be suppressed in glossiness in the first region by applying the ink only to the first region or applying the ink having a smaller gloss value to the first region. That is, with the shapes of the base material illustrated in FIG. 1, FIG. 3, and FIG. 5, in relation to the reflected light, the degree of glossiness in the region in the vicinity of the center is more likely to be sensed higher than the degree of glossiness in the region therearound. Therefore, in order to intentionally reduce the degree of glossiness in the region in the vicinity of the center, the gloss value may be adjusted so as to be higher in the second region than in the first region, or the ink may be applied only to the first region. With this, the formed body can give an observer such a visual impression that a curve which is smaller than an actual degree of the curve is given.

<Method for Producing Formed Body (Case Other than the Ultraviolet Curable Inkjet Ink)>

A method for producing a formed body according to one embodiment of the present invention mainly includes: a step of applying the ink described above to a base material by an inkjet method; and a step of drying the base material. The base material may be formed into a desired shape in advance, or a forming step of forming the base material into a desired shape after drying may be adopted.

### (Applying Step)

The method of applying the ink constituting the ink set to the base material by the inkjet recording method is not particularly limited. Examples of such method include: continuous methods such as a charge modulation method, a micro-dot method, a charge jet control method, and an ink mist method; and on-demand methods such as a piezoelectric method, a pulse jet method, a bubble jet (registered trademark) method, and an electrostatic suction method.

An inkjet device for applying the ink is a device supplies the ink from an ink tank to a compression chamber through an ink supply passage and applies an electric signal corresponding to image data to a piezoelectric element to drive the piezoelectric element, to thereby deformed a vibration plate constituting a part of the compression chamber to reduce a volume of the compression chamber and eject the ink in the compression chamber through an ejection port of a nozzle (head).

The head is classified into a shuttle method (multi-path method) and a line method (single path method). In the multi-path method, a serial head having a short length is used to perform recording while scanning the head in a width direction of the base material. Meanwhile, in the single path method, a full line head which covers an entire region of the base material is used to form an image on an entire surface of the base material by an operation of moving the full line head and the base material relative to each other only one time.

According to the method for producing the formed body according to the present embodiment, the printed matter is produced through use of the inkjet device adopting the single path method so that the ejection amount for each printing can be set larger, and the ink can be applied to the base material in a short period of time, thereby being capable of improving productivity of the printed matter.

According to the method for producing the formed body according to the present embodiment, through the application of the ink, there can be formed the first region, the second region, or both of the regions described above are formed on the base material. With this, a plurality of regions having gloss values different from each other are formed on the base material.

### (Drying Step)

The base material to which the ink has been applied is then dried. Drying conditions are not particularly limited. For example, it is preferred that a drying temperature be 150° C. or more, more preferably 180° C. or more, further preferably 200° C. or more. Moreover, it is preferred that the drying temperature be 400° C. or less, more preferably 350° C. or less, further preferably 300° C. or less. It is preferred that a drying time period be 1 minute or more, more preferably 2 minutes or more, further preferably 3 minutes or more. Moreover, it is preferred that the drying time period be 60 minutes or less, more preferably 30 minutes or less, further preferably 10 minutes or less. With such drying, a pigment in the ink is less liable to be changed in color, and the solvent may be removed. In order to prevent bleeding of the ink, it is preferred that the drying be performed simultaneously with or immediately after application of the ink to the base material.

An obtained printed matter has a first region and a second region having gloss values different from each other. At least any one of the first region and the second region is a region to the ink is applied. As described above, according to the present embodiment, a printed matter excellent in design in which a plurality of regions having different gloss values are formed by the inkjet method on the base material can be obtained.

### <Method for Producing for Formed Body (Case of the Ultraviolet Curable Inkjet Ink)>

A method for producing an inkjet printed matter according to one embodiment of the present invention (hereinafter simply referred to as “method for producing a printed matter”), particularly in a case of producing the inkjet printed matter through use of the ultraviolet curable ink described above, mainly includes: a step of applying the ink to a base material by an inkjet method; and a step of curing the applied ink through irradiation with an ultraviolet ray. In the following, a description is made of each step.

### (Applying Step)

The applying step is a step of applying the ink to the base material by the inkjet method. The base material is not particularly limited. As the base material, there may be used the same base material as the one described above. As an inkjet device for applying the ink, there may be used the same inkjet device as the one described above.

The base material may have, on a surface thereof, a chemical conversion coating film or an undercoating film. The chemical conversion coating film is formed on an entire surface of the base material and may improve the adhesion and corrosion resistance of the coating film. The undercoating film is formed on a surface of the base material or the chemical conversion coating film and may improve the adhesion and corrosion resistance of the coating film. A resin included in an undercoating material for forming the undercoating film is not particularly limited. Examples of the resin include a polyester resin, an epoxy resin, and an acrylic resin.

In the method for producing the formed body according to the present embodiment, the ink is applied to form the first region, the second region, or both of the regions described above are formed on the base material. With this, a plurality of regions having gloss values different from each other are formed on the base material.

### (Curing Step)

The curing step is a step of irradiating the applied ink with ultraviolet rays to cure the ink. The ink having been ejected to the base material is irradiated with an ultraviolet ray through use of an ultraviolet ray radiation lamp provided to the inkjet device and is cured. Examples of the ultraviolet ray radiation lamp include a mercury lamp and gas/solid laser. Among those, it is preferred that the ultraviolet ray radiation lamp be a mercury lamp or a metal halide lamp. Other ultraviolet ray radiation lamps such as an ultraviolet light-emitting diode (UV-LED) or an ultraviolet laser diode (UV-LD) may be adopted.

An integrated light intensity of the ultraviolet ray given at the time of curing is not particularly limited. It is preferred that the integrated light intensity be 40 mJ/cm² or more, more preferably 60 mJ/cm² or more. Moreover, it is preferred that the integrated light intensity be 500 mJ/cm² or less, more preferably 400 mJ/cm² or less. The integrated light intensity can be measured through use of, for example, an ultraviolet illuminometer/actinometer (UV-351-25, manufactured by ORC MANUFACTURING CO., LTD.), under conditions of a measurement wavelength range of 240 to 275 nm and a measurement wavelength center of 254 nm.

An obtained printed matter has a first region and a second region having gloss values different from each other. At least any one of the first region and the second region is a region to which the above-described ink is applied. As described above, according to the present embodiment, a printed matter excellent in design in which a plurality of regions having different gloss values are formed by the inkjet method on the base material can be obtained.

### (Forming Step)

The base material to which the above-described ink has been applied is suitably formed into a desired shape. A forming method for the base material is not particularly limited. Examples of the forming method include extrusion molding, inflation molding, calendar molding, and cast molding. The base material may be formed into a desired shape by those forming methods. When the ink is applied to the base material having been formed in advance, the forming step may be omitted.

As described above, with the method for producing the formed body according to the present embodiment, a formed boy having a plurality of regions with different degrees of matteness (gloss values) is obtained. At least any one of the regions is a region to which the ink is applied by the inkjet method. Therefore, a degree of matteness (gloss value) of the formed body may easily be adjusted, for example, by suitably changing conditions of inkjet printing. Further, the formed body has a plurality of regions (first region and second region) having gloss values different from each other. Therefore, as compared to a formed body to which monotonous matteness is given by coating, the design is more excellent.

### REFERENCE SIGNS LIST

1, 1a, 1b formed body
2, 2a, 2b base material
3, 3a related-art formed body
A1, A1a, A1b first region
A2, A2a, A2b second region

What is claimed is:

1. A formed body, comprising a first region and a second region having gloss values different from each other,
wherein at least any one of the first region and the second region is a region to which an inkjet ink is applied.

2. The formed body according to claim 1,
wherein the inkjet ink includes particles having an average particle diameter of 0.4 to 2.5 μm, a refractive index of 1.40 to 1.70, and a specific gravity of 2.1 or less, and
wherein the particles are included in at least any one of the first region and the second region.

3. The formed body according to claim 1, further comprising:
a curved surface; and
a non-curved surface formed around the curved surface,
wherein the first region is formed on the curved surface, and
wherein the second region is formed on the non-curved surface.

4. The formed body according to claim 1, further comprising:
a first curved surface; and
a second curved surface formed around the first curved surface,
wherein the first region is formed on the first curved surface, and
wherein the second region is formed on the second curved surface.

5. The formed body according to claim 1, wherein a difference in gloss value (AG) between the first region and the second region is from 0.5 to 95.

6. The formed body according to claim 1, wherein the formed body is an interior component of an automobile.
